(19) United States
(12) Patent Application Publication
(10) Pub. No.: US 2007/0036535 A1
(43) Pub. Date: Feb. 15, 2007

(54) Motion detection automatic camera

(75) Inventor: Alexander B. Chee, Marietta, GA (US)

Correspondence Address: Chun-Ming Shih, 4331 Stevens Battle Lane, Fairfax, VA, 22033, US

(73) Assignee: Pro Brand International, Inc.

(21) Appl. No.: 11/202,174

(22) Filed: Aug. 12, 2005

(51) Int. Cl. G03B 17/00

(52) U.S. Cl. 396/153

(57) ABSTRACT

A motion detection camera device includes a housing, a camera, at least two motion detectors, and a controller. The camera is located within the housing. The motion detectors on the housing are used to detect motions a distance away from the housing, whereby a core zone includes partial detecting zones of each and every motion detector and the core zone within a picture taking zone of the camera. The controller is for controlling the camera, whereby receiving signals from the motion detectors and giving a picture taking signal to the camera when an object enters the core zone. As such, a desired object in the position of picture is controlled and over sensitivity or over insensitivity of a single motion detector is avoided.

References of interest in the disclosure of the invention, the contents of which are incorporated herein by reference, include:

| | | | |
|---|---|---|---|
| 5,155,474 A | 10/1992 | Park et al. | 340/691.5 |
| 5,309,145 A | 5/1994 | Branch et al. | 340/540 |
| 5,400,185 A | 3/1995 | Scerbo, III | 360/5 |
| 5,610,580 A | 3/1997 | Lai | 340/541 |
| 5,666,582 A | 9/1997 | Nakai et al. | 396/419 |
| 5,819,124 A | 10/1998 | Somner et al. | 396/263 |
| 5,878,283 A | 3/1999 | House et al. | 396/6 |
| 6,289,179 B1 | 9/2001 | You | 396/205 |
| 6,735,387 B1 | 5/2004 | Schnell | 396/263 |
| 6,768,868 B1 | 7/2004 | Schnell | 396/263 |
| 6,834,162 B1 | 12/2004 | Schnell | 396/153 |

### BACKGROUND OF THE INVENTION

The present invention relates to a motion detection automatic camera. More particularly, the present invention relates to a motion detection automatic camera that can be used in hunting and home and business security.

The conventional motion detection cameras use single motion detector system. Frequently an infrared motion detector is used in such system. FIG. 1 illustrates the angle coverage arrangement of the conventional system. As shown in FIG. 1(a), when a wide angle coverage motion detector is used in the system, the motion detector angle coverage is equal or slightly smaller then the camera angle coverage. One short come of using a wide angle motion detector is that the desired object is always at the edge of the pictures. When a desired object enters motion detector's detecting zone, the camera takes a picture immediately and the desired object is then at the edge of the picture. When a narrow angle motion detector is used, as shown in FIG. 1 (b), it can solve the problem of the desired object at picture edge. But the narrow angle motion detector needs higher sensitivity within the detecting zone so that it would not miss the desired object. The high sensitivity within the detecting zone can cause undesired triggering of the motion detector when an insect flies or a leaf moves with in the detecting zone.

Another disadvantage of a single motion detector camera system is that the system does not give any preparation time to camera. In some advanced systems, the camera is usually an automatic focusing camera. The camera needs some time to adjust focus before taking a picture.

The present invention intends to improve above issues, either in partial or in whole. The detail of the invention will be further discussed in detail description of the invention.

### SUMMARY OF INVENTION

The present invention is directed to a motion detection automatic camera for hunting and security that overcomes the disadvantages of the prior art. Specifically, the present invention relates to an improved motion detection camera with at least two motion detectors for controlling a desired object in the position of picture and for avoiding over sensitive or over insensitive of a motion detector.

The present invention relates to a motion detection automatic camera device that has a house, a camera, at least two motion detectors, a controller, a picture status indicator, a test status indicator, a photo sensor, a flash, and batteries. The camera system is either a mechanical film camera system or a digital camera system. The motion detectors are any kind motion detectors, which include infrared motion detectors. The two or more motion detectors used in the system can be same type motion detectors and also the motion detectors can be different types of detectors. The controller includes at least one microcontroller and circuitries to make the controller functional. The status indicator can be a light, a single light-emission-diode (LED), a liquid-crystal display, or another commercially available indicator. The present invention is usually fastened to a tree or a post, which is in front of a desired object frequent trail or a place that a desire object most likely to appear. When the desire object appears within the first motion detector detecting range, the first motion detector sends a signal to the controller. After the controller receives the signal from first motion detector, the controller sends the preparation signal to the camera system. The controller then ignores further signals from the first motion detector after receiving the first signal from the first motion detector. The camera starts focusing on the desired object. When the desired object advances further, the object moves into the center of camera picture taking zoon and triggers the second motion detector. The second motion detector sends a signal to the controller and the controller sends the picture taking signal to the camera. The camera takes a picture. The controller then resets for next cycle. The photo sensor detects the light density and sends signals to the controller. The controller sends a signal to the flash if light condition is not adequate for the preset requirement of a picture taking.

Other advantages and uses for the present invention will be more clearly understood by reference to the following description and drawings.

### BRIEF DESCRIPTION OF THE DRAWINGS

FIGS. 1(a) and (b) illustrate conventional motion detecting system FIG. 2 is a front view of one example embodiment of present invention.

FIG. 3 is a view of inside box arrangement of present invention.

FIG. 4 is the control function chart of present invention

FIG. 5 illustrates motion detecting system of present invention

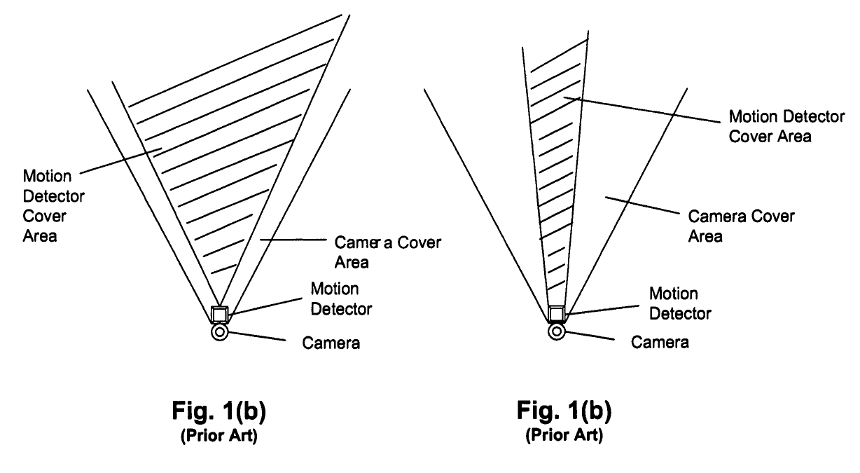

### DETAILED DESCRIPTION OF THE INVENTION

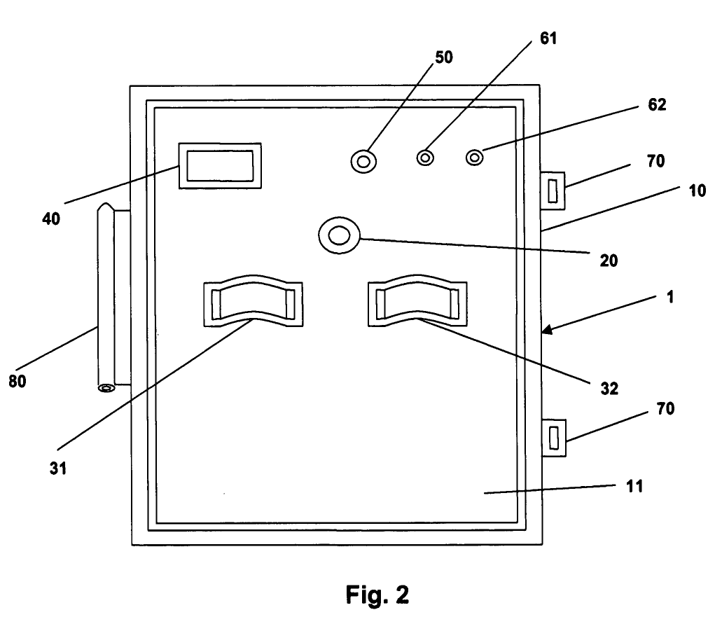

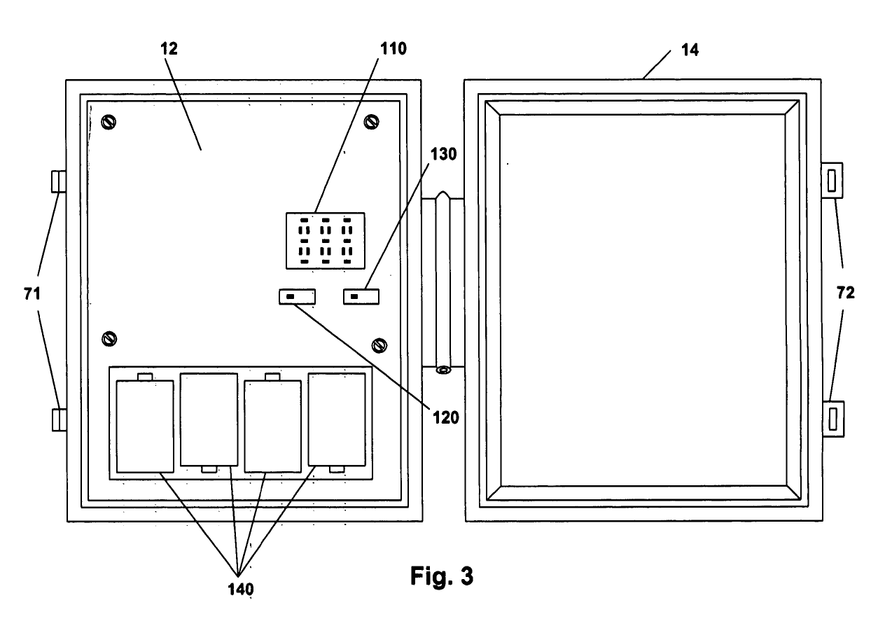

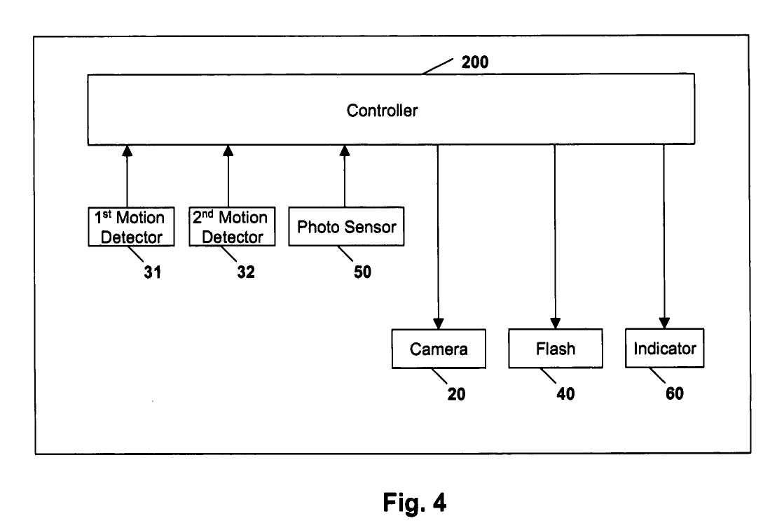

FIGS. 2, 3, and 4 illustrate one example of a motion detection automatic camera according to the principle of the present invention in the front cover and in the center cover form and the control method. The example camera comprises a house 10, two motion detectors 31 and 32, a camera 20, a flash 40, a photo sensor 50, a picture indicator 61, a test indicator 62, a picture number display 110, a flesh on/off control switch 120, a test/picture switch 130, and a controller 200. The batteries 140 provide DC power to the camera.

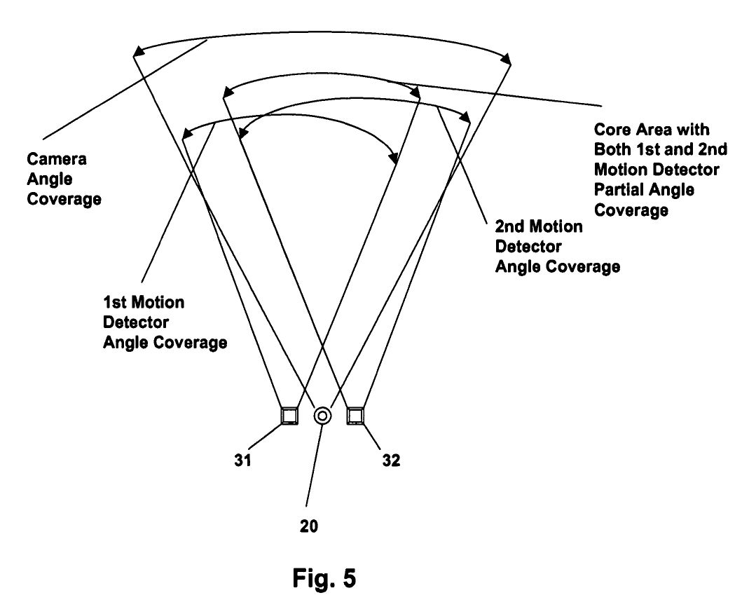

FIG. 5 illustrates one example based on the basic principle of the present invention. There are an angle coverage area of camera 20, an angle coverage area of the first motion detector 31, and an angle coverage area of second detector 32. The angle coverage of the camera 20 covers the angle coverage of the first motion detector 31 and the angle coverage of the second motion detector 32 in partial or in whole. There is a core area cross coverage of first motion detector 31 and second motion detector 32 and the core area is within the coverage of the camera 20. When a desired object enters first motion detector 31 covering area, the first motion detector 31 detects the motion and sends a signal the controller 200. The controller 200 then sends a preparation signal to the camera 20 and the camera 20 can start to adjust focus to the object The controller 200 checks light condition by read photo sensor 50 output. The controller 200 then makes decision to flash or not when the flash switch 120 is at “on” position. When the object moves further to reach the coverage area of the second motion detector 32, the second detector 32 sends a trigger signal to the controller 200. The controller 200 then sends a picture taking signal to the camera 20 and the camera 20 takes a picture. At same time, the controller 200 also sends a trigger signal to the flash 40 if in previous time the controller 200 determined to flash, and the flash 40 flashes at the same time of the camera 20 is taking the picture.

Because these two detectors 31 and 32 are symmetric, the order of sending trigger signals can be reversed. The second detector 32 detects a desired object and sends a signal to the controller 200. The controller 200 then sends a preparation signal to the camera 20 and the camera 20 can start to adjust focus to the object. The controller 200 checks light condition by read photo sensor 50 output. The controller 200 then makes decision to flash or not when the flash switch 120 is at “on” position. When the object moves further to reach the coverage area of the first motion detector 31, the first detector 31 sends a trigger signal to the controller 200. The controller 200 then sends a picture taking signal to the camera 20 and the camera 20 takes a picture. At same time, the controller 200 also sends a trigger signal to the flash 40 if in previous time the controller 200 determined to flash, and the flash 40 flashes at the same time of the camera 20 is taking the picture.

After the picture is taken, the controller 200 waits a preset short period time to let the object leave detecting zones of detectors 31 and 32. Then the controller 200 resets the memory inside of the controller 200 to start a new picture cycle.

The principle of present invention can be extended to a multi-detector camera to one or few restricted picture taking core zones by a skilled person in the art.

The test/picture switch 130 is used to assistant to setup the motion detection camera 1. If the switch 130 is on test position, the controller 200 will not send out a picture taking signal to the camera 20 when the orderly signals from the detectors 31 and 32 have been received by the controller 200. The picture indicator 61 shows the status of the motion detection camera 1. The usual configuration is that light-on indicates ready and that light-off indicates not ready for picture taking. The test indicator 62 has a different color then the picture indicator 61. The test indicator 62 has three modes. The usual configuration is that light-on steady indicates both detector 31 and 32 have no signal out, that long period blinking indicates one of the two detectors has sent a signal, and that short period blinking indicates both detectors have sent sequence signals. The short period blinking indication only holds for a preset short period of time. After the period of time, the controller 200 resets the memory and starts a new test cycle.

It will be further understood by those skilled in the art that while the present invention has been described above with reference to preferred embodiments, numerous variations, modifications, and additions can be made thereto without departing from the spirit and scope of the present invention as set forth in the following claims.

I claim:

1. A motion detection camera device comprises:
a housing;
a camera located within the housing;
at least two motion detectors on the housing to detect motions a distance away from the housing, whereby a core zone including partial detecting zones of each and every motion detector and the core zone within a picture taking zone of the camera;
a controller for controlling the camera, whereby receiving signals from the motion detectors and giving a picture taking signal to the camera when an object enters the core zone.

2. The motion detection camera device of claim 1, further including a flash on the housing.

3. The motion detection camera device of claim 1, further including at least one indictor.

4. The motion detection camera device of claim 1, wherein the motion detectors include infrared sensors.

5. The motion detection camera device of claim 1, further including at least one battery located within the housing.
